(19) United States
(12) Patent Application Publication
(10) Pub. No.: US 2012/0141641 A1
(43) Pub. Date: Jun. 7, 2012

(54) DISPENSING CONTAINER

(76) Inventor: Andrew Michael Wells, Milton Keynes (GB)

(21) Appl. No.: 13/390,638

(22) PCT Filed: Aug. 13, 2010
(86) PCT No.: PCT/GB10/51344

§ 371 Date: Feb. 15, 2012

(30) Foreign Application Priority Data
Aug. 18, 2009 (GB) 0914428.8
Mar. 8, 2010 (GB) 1003810.7
Aug. 4, 2010 (GB) 1013065.6

(51) Int. Cl. B65D 83/76; G01F 11/00

(52) U.S. Cl. 426/115; 222/386

(57) ABSTRACT

A dispensing container (400) for storing and dispensing liquid and/or semi-solid foods that has a hollow body (3), a base (4), a piston (405) with a passage (6) through it and a tube (52). The tube (52) is releasably secured to the piston (405) for movement with it and in fluid communication with the passage (6). The piston (405) is slidably received within the body (3) and movable along it toward the base (4) to dispense through the tube (52) a liquid and/or semi-solid food from the container (400).

This invention relates generally to dispensing containers and more specifically, although not exclusively, to dispensing containers, e.g. single or multi-use dispensing containers, for liquid and/or semi-solid food such as yoghurts, ice-creams (in their frozen and melting states), baby foods having a paste-like or porridge-like consistency and/or to liquidized or semi-liquidized fruits or vegetables, e.g. for the elderly or infirm.

Known single use containers for yoghurt and the like are generally in the form of a tub having a square, circular or oval shaped cross-sectional profile and a peripheral flange about its rim. They often include a plastic and/or foil closure which is glued or heat sealed to the flange. In use, the closure is removed to provide access to the contents of the container, which are usually consumed using a separate utensil such as a spoon. This arrangement is not ideal where, for example, a consumer wishes to consume the product immediately. Whilst not common, some such containers include a utensil, e.g. a collapsible utensil, associated therewith or attached thereto.

Similarly, for the elderly and infirm the use of dispensing utensils for consuming food is often difficult as their coordination may have deteriorated and/or be impaired. Mastication can also be an issue and it is common for their food to have a liquidized or porridge-like consistency.

It is therefore a first non-exclusive object of the invention to provide a dispensing container design that is applicable to both single use and multi-use applications and which overcomes or at least mitigates the aforementioned issues. It is a more general non-exclusive object of the invention to provide an improved and/or more versatile dispensing container.

Accordingly, one aspect of the invention provides a dispensing container, for example a single-use or multi-use dispensing container, for storing and dispensing liquid and/or semi-solid foods, the container comprising a hollow body, a base, a piston with a passage therethrough and a tube releasably secured to the piston for movement therewith and in fluid communication with the passage, wherein the piston is slidably received within the body and movable therealong toward the base, e.g. in response to a sucking action applied, in use, by a user or consumer to the passage and/or to dispense, in use, through the tube a liquid and/or semi-solid food from the container.

Thus, a user or consumer is able to consume the contents of the dispensing container conveniently, without the need for any separate utensils or the like.

The container may comprise an actuator or actuator means, which may be connected, for example releasably connected, to the piston and/or to the tube, e.g. for urging, in use, the piston toward the base for example to reduce or eliminate the need for sucking action to be applied.

The actuator or actuator means may comprise a biasing element or means, e.g. configured to bias, in use, the piston toward the base. For example, the biasing means may comprise a resilient biasing means such as an elastomeric strip or band or spring, which may interconnect or be interconnected between the piston and the body.

In some embodiments, the body includes one or more, preferably two, grips or handles to which the biasing means or element, e.g. a first end of the biasing means or element, may be connected or releasably connected. Conveniently, the tube may be configured to be secured to or fit into the or one of the handles for storage, for example by virtue of its external dimensions, e.g. its diameter, being less than the internal dimensions, e.g. diameter, of the handle or handles. The container may also include a support connected or fixed or secured to the piston and/or tube to which the biasing means or element, e.g. a second end of the biasing means or element, may be connected or releasably connected.

Additionally or alternatively, the actuator or actuator means may comprise an actuation member, for example a chin rest, e.g. that includes a soft or flexible material thereon such as a foam material. The actuator or actuator means may be secured or releasably secured to the piston and/or tube, e.g. to the support. For example, the actuator or actuator means may comprise a connecting or securing element or tab, which may comprise one or more, preferably two or more, most preferably three, elements or tabs or plates or sheets or leaves, e.g. formed of a plastics material. The or each element or tab or plate or sheet or leaf may include an aperture or hole through which the tube and/or a spigot portion of the piston, e.g. that incorporates the passage, extend. Additionally or alternatively, the connecting or securing element may comprise a clamp or clamping means configured to grip or clamp the tube or spigot or piston.

The container may further comprise an anti-removal element or tab, which may comprise a sheet, e.g. formed of a plastics material, that may be folded into two leaves. Each leaf may include an aperture or hole through which the tube and/or a spigot portion of the piston, e.g. that incorporates the passage, extend.

Preferably, the tube is elongate and/or flexible and/or corrugated and/or folded or foldable and/or formed of a material with a structural memory, for example such that it expands to a circular shape when it is released, in use, e.g. for easy manipulation and/or packaging. More preferably, the tube comprises a straw.

A second aspect of the invention provides a dispensing container, for example a single-use or multi-use dispensing container, for storing and dispensing liquid and/or semi-solid foods, the container comprising a hollow body, a base, a piston with a passage therethrough and a flexible tube secured to the piston for movement therewith and in fluid communication with the passage, wherein the piston is slidably received within the body and movable therealong toward the base in response to a sucking action applied, in use, by a user or consumer to the passage.

The passage is preferably in fluid communication with a reservoir defined between the piston the body and the base. More preferably, the piston is configured and/or sized and/or dimensioned to be movable in response to the sucking action applied to the pipe or tube.

The piston is preferably configured and/or sized and/or dimensioned to cooperate with the hollow body, for example the internal surface or surfaces of the hollow body, to provide a substantially fluidic and/or airtight seal. The container or piston may comprise a sealing or scraping element associated with a peripheral or circumferential surface or sidewall thereof, for example which cooperates with the internal surface or surfaces of the hollow body, e.g. to provide a sealing engagement therewith or to scrape food residue therefrom. The sealing or scraping element may comprise a ring or flange extending from the peripheral or circumferential surface or sidewall. The sealing or scraping element may be formed integrally with the piston or may engage the piston, for example the sealing or scraping element may comprise a seal, e.g. an o-ring seal, or scraper, e.g. a scraper ring, which may be receivable within a recess or groove in the piston. The piston may be circular, rectangular, square octagonal or any other shape in plan.

The piston may comprise a recess within which the flexible tube is receivable. The piston may comprise a hollow or solid plate or disc or cylinder, for example with a hole through its thickness to provide the passage, e.g. with the or a sealing or scraping element associated with its peripheral or circumferential surface or sidewall. The piston may comprise an internal container facing surface or side which may be flat, planar, convex or concave.

Additionally or alternatively, the piston may comprise a plate or disc or panel or base panel, or sheet, e.g. extending across the tubular body, which may include a hole through its thickness to provide the passage. The piston or plate or disc or panel or base panel or sheet may further include a side wall or skirt, for example extending from the plate, disc, panel or sheet, e.g. extending from a peripheral portion thereof, e.g. defining the recess and/or for sealing or scraping against the tubular body or guiding the piston therealong. The piston may further include a second plate or disc or panel or sheet, for example connected to the side wall or skirt and/or offset from and/or lying parallel to the first plate, disc, panel or sheet. The plate, disc, panel or sheet may be flat, planar, concave or convex.

The container may include a closure or lid, for example a foil, film or sheet, which may be connected, e.g. adhered or bonded, preferably releasably connected, adhered or bonded, to the tubular body, e.g. a rim or peripheral flange of the tubular body. The lid or foil or film or sheet is preferably formed of a plastics material and/or may include a foil. The closure may comprises a perforated line, e.g. defining a removable portion of the closure. The perforated line may be configured such that a portion of the closure remains on the tubular body, in use, for example to inhibit removal of the piston. In some embodiments, the perforated line extends about and/or adjacent and/or marginally of the periphery of the closure, for example defining a marginal portion that may provide or serve as a lip for preventing or inhibiting removal of the piston. Other embodiments may include two, or even three or more, perforated lines, for example which may be parallel to one another and/or may extend across the closure to define a removable portion, e.g. a central removable portion.

Additionally or alternatively, the closure or lid may comprise a snap-on or screw top lid or any other suitable type of closure and/or may comprise a tamper evident means or member.

The straw may comprise a mouthpiece, which mouthpiece may comprise or be located at an open end of the straw. The straw or mouthpiece may be connected to and/or extend through the closure or lid. The container or closure or lid may include a cap, e.g. for covering an open end of the straw or for covering the mouthpiece. The cap may comprise the tamper evident means or member, e.g. the cap may comprise a tamper evidence band.

The container may further comprise a clip for releasably securing the flexible tube or mouthpiece to the container or piston.

Embodiments of the invention will now be described by way of example only with reference to the accompanying drawings in which:

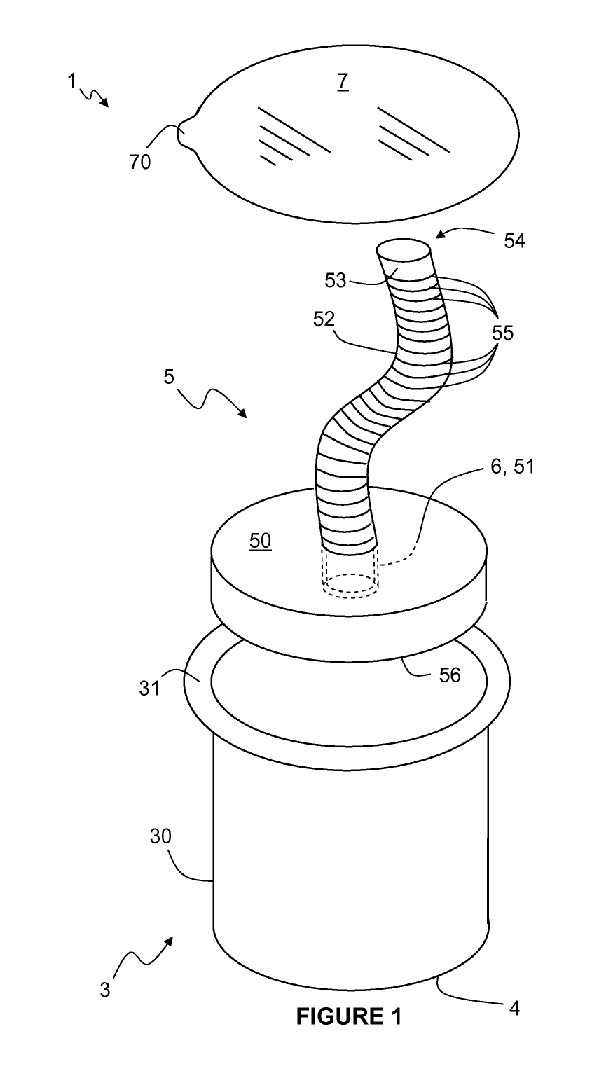

FIG. 1 is an exploded perspective view of a dispensing container according to a first embodiment of the invention;

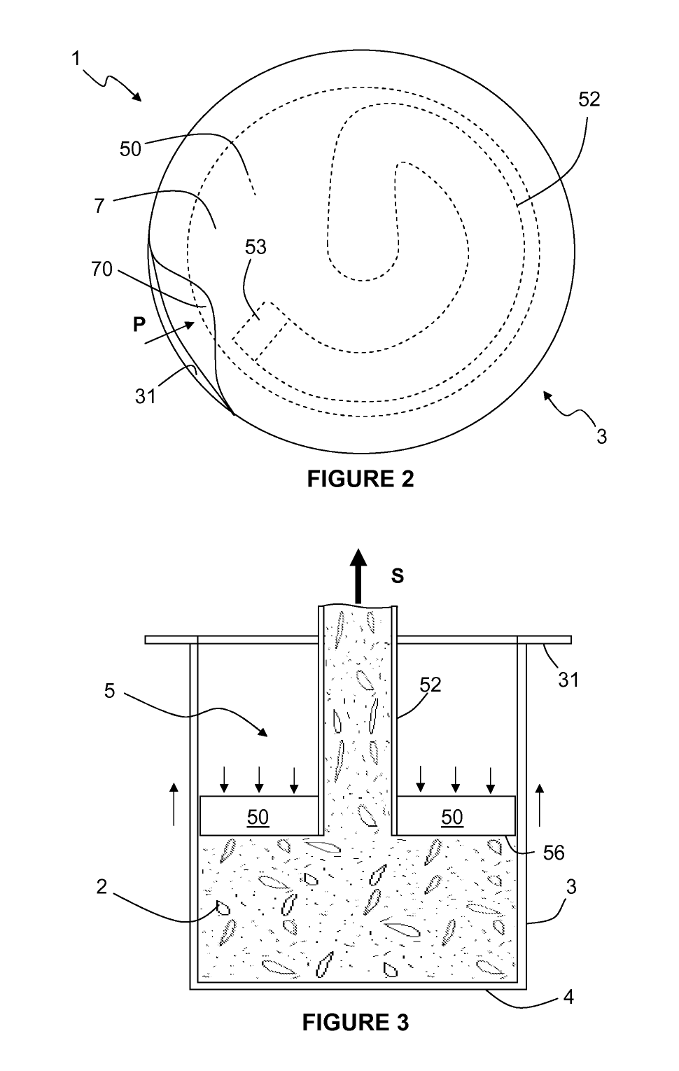

FIG. 2 is a top view of the container of FIG. 1 shown in an assembled condition and illustrating the removal of the closure film;

FIG. 3 is a cross-sectional view through the centre of the container of FIGS. 1 and 2 showing the dispensing container in use;

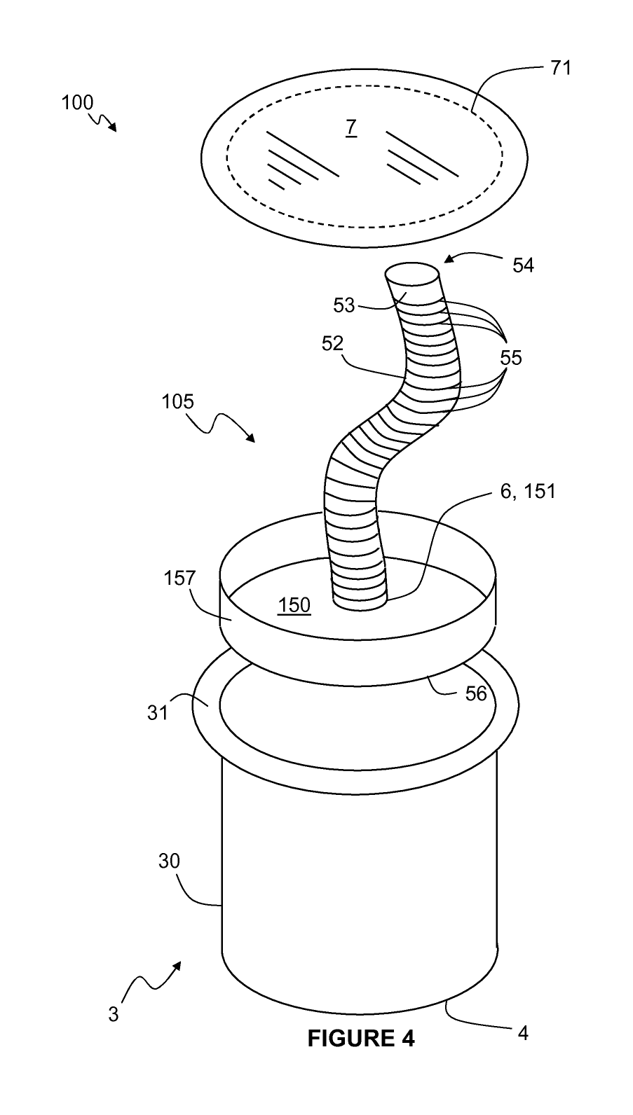

FIG. 4 is an exploded perspective view of a dispensing container according to a second embodiment of the invention;

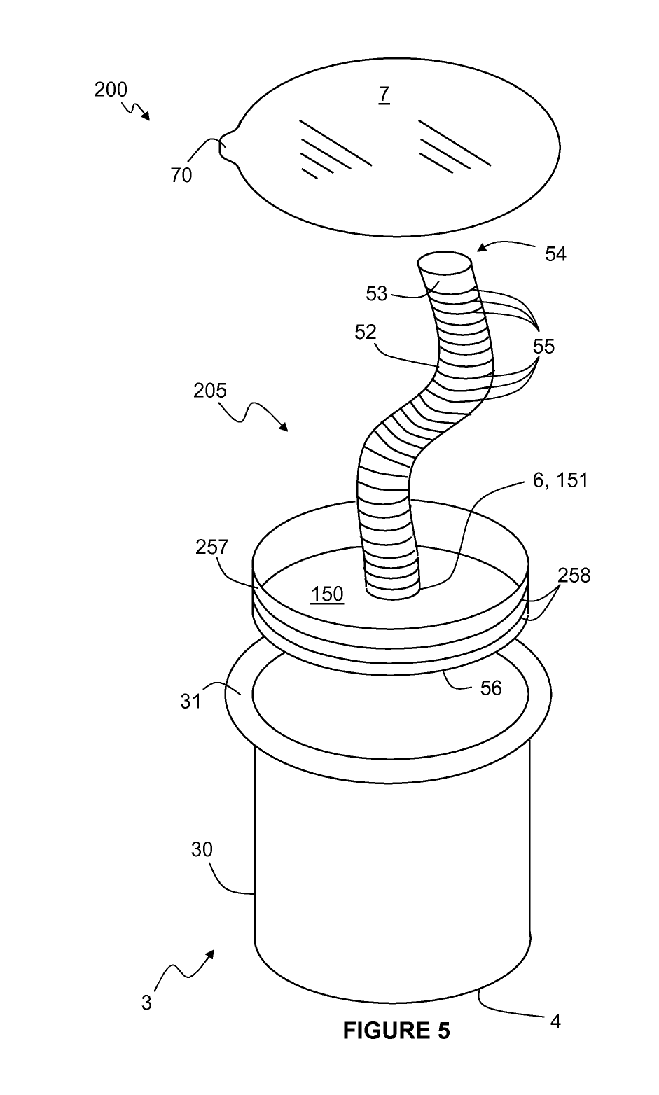

FIG. 5 is an exploded perspective view of a dispensing container according to a third embodiment of the invention;

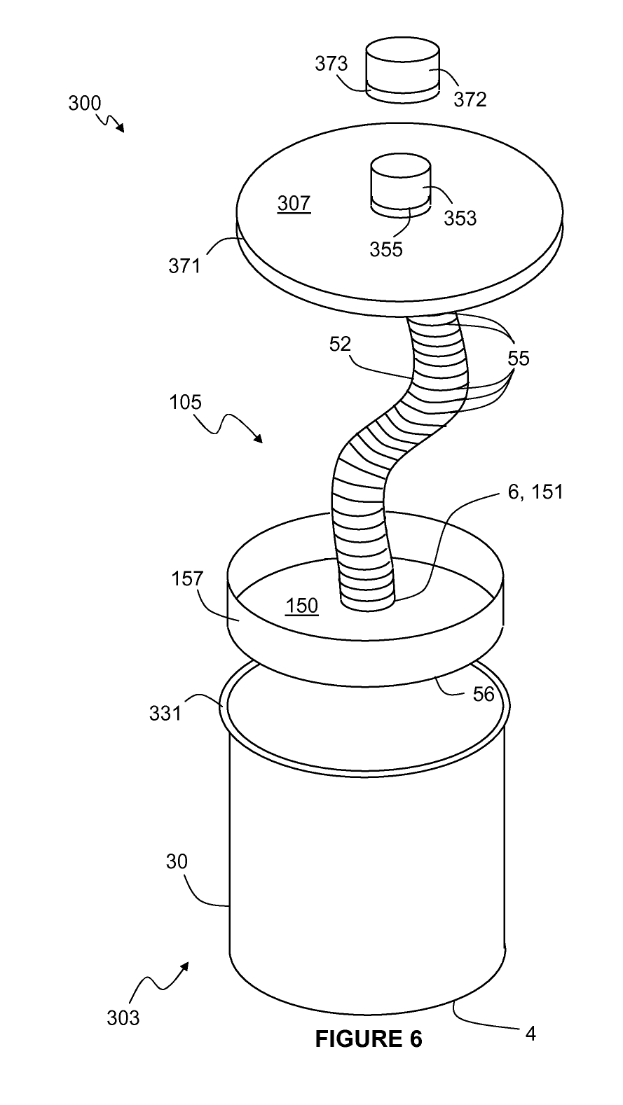

FIG. 6 is an exploded perspective view of a dispensing container according to a fourth embodiment of the invention;

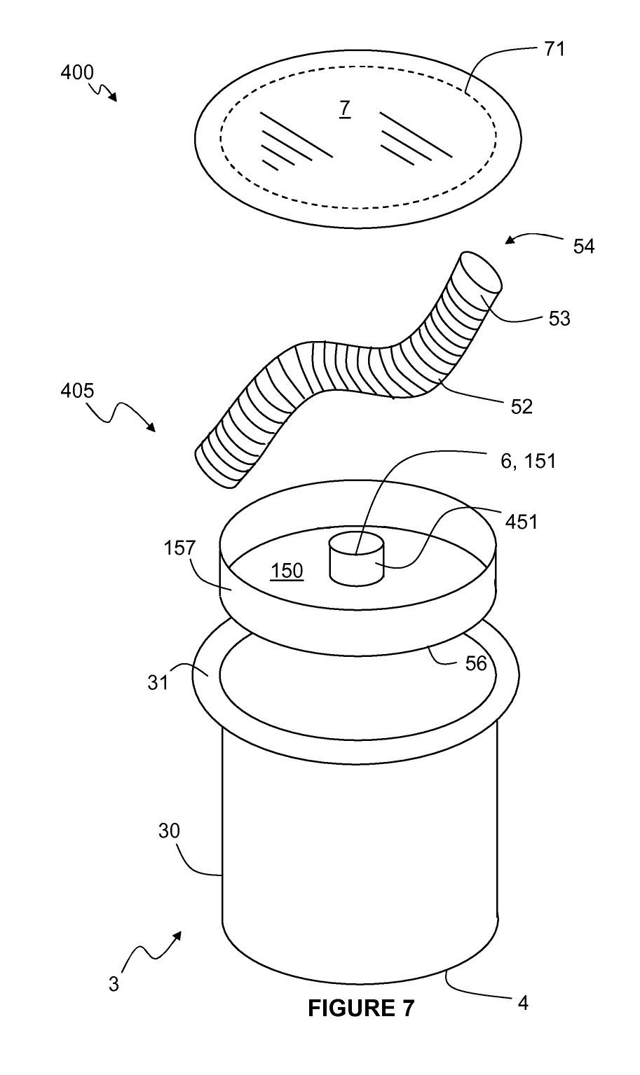

FIG. 7 is an exploded perspective view of a dispensing container according to a fifth embodiment of the invention;

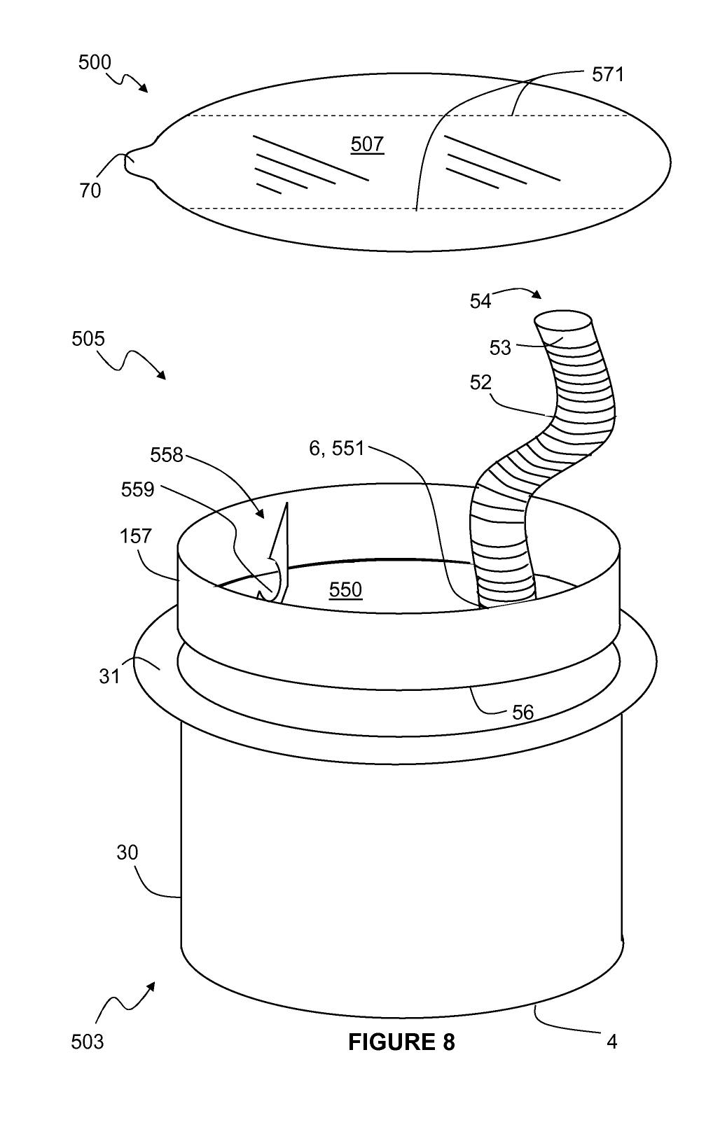

FIG. 8 is an exploded perspective view of a dispensing container according to a sixth embodiment of the invention;

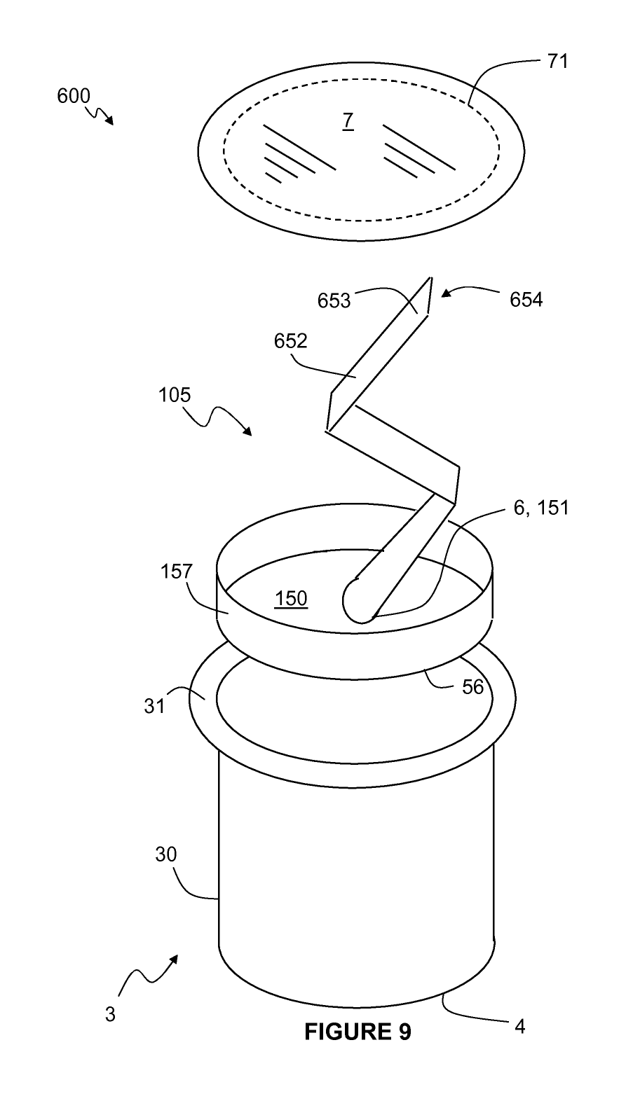

FIG. 9 is an exploded perspective view of a dispensing container according to a seventh embodiment of the invention;

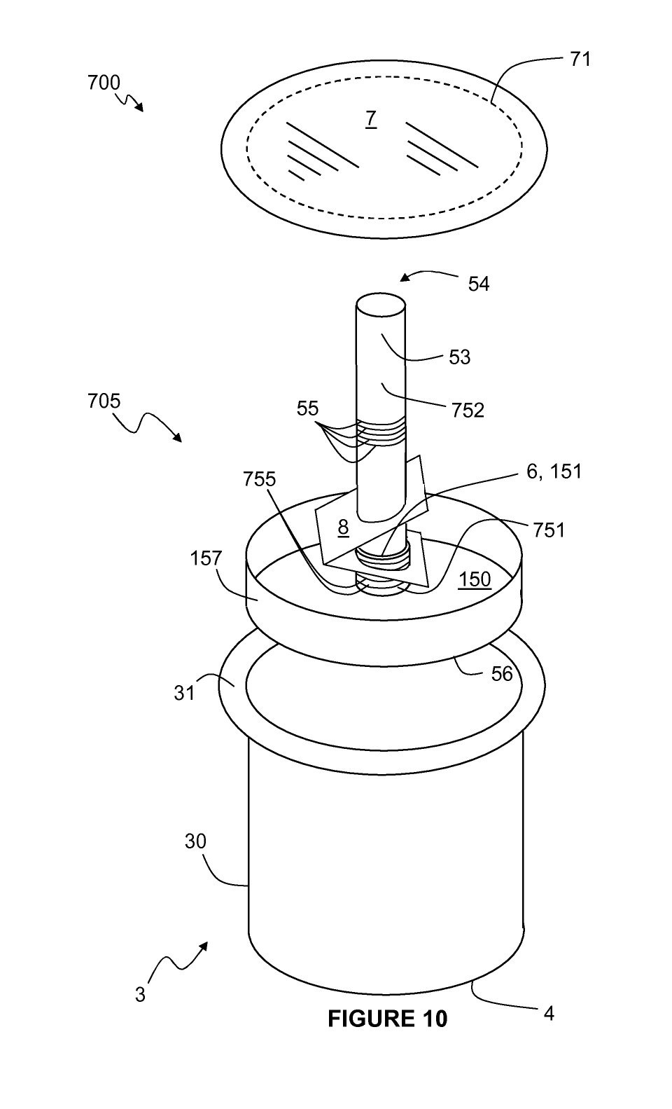

FIG. 10 is a partially exploded perspective view of a dispensing container according to an eighth embodiment of the invention;

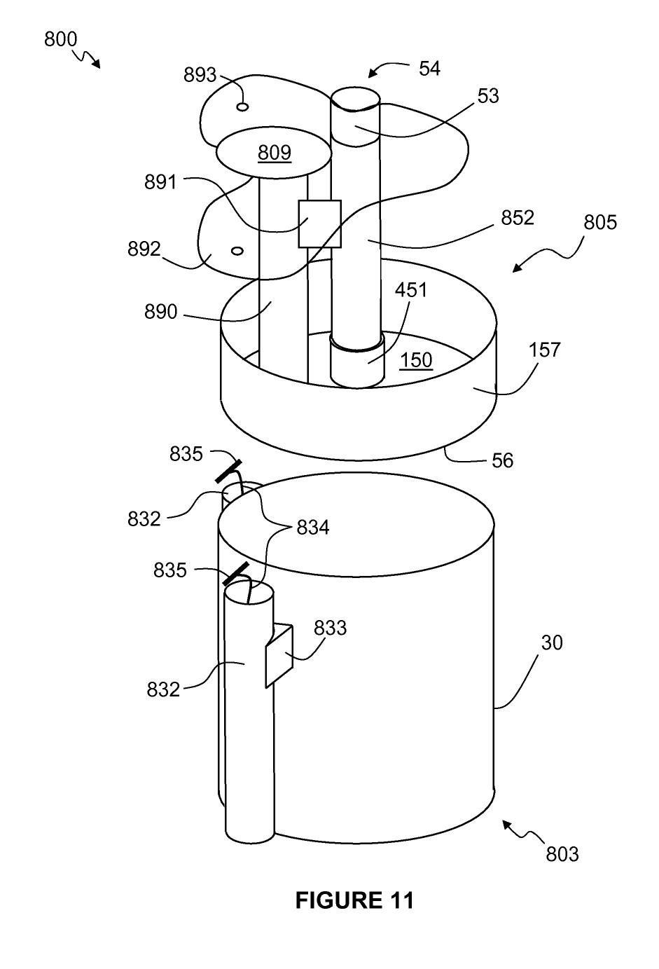

FIG. 11 is a partially exploded perspective view of a ninth embodiment of the invention; and

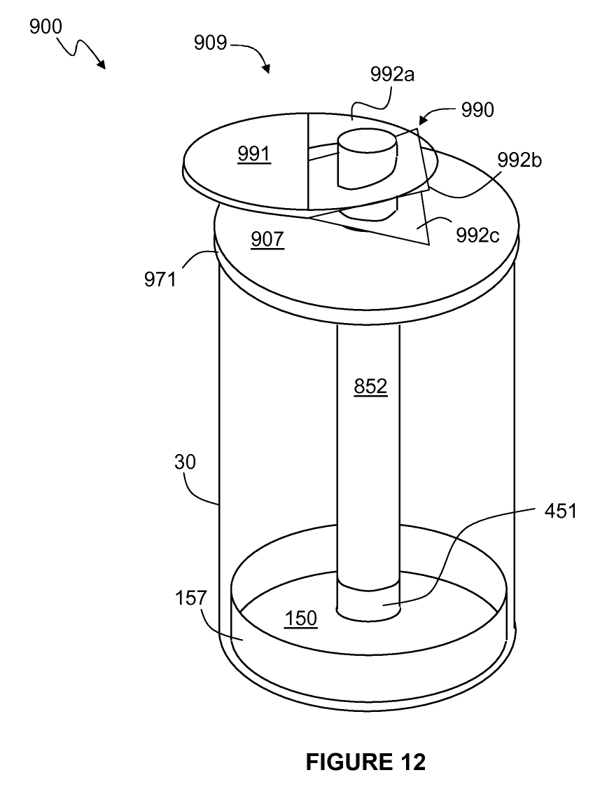

FIG. 12 is a perspective view of a tenth embodiment of the invention.

In FIGS. 1 to 3 there is shown a dispensing container 1, a single-use dispensing container 1 in this embodiment, for storing and dispensing semi-solid foods 2. The container 1 includes a hollow body 3 with a base 4, a piston 5 with a passage 6 therethrough and a closure film 7 for sealing the container 1.

The body 3 in this embodiment is a thermoformed or vacuum formed yoghurt pot with a hollow cylindrical portion 30, a base 4 at the bottom of the cylindrical portion 30 and a peripheral flange 31 at the top thereof, all of which are formed integrally. It will be appreciated that the cylindrical portion 30 includes a small draft angle and rounded corners (not shown) for manufacturability.

The piston 5 is in the form of a relatively thin solid cylinder 50 with a passage 6 provided by a hole or aperture 51 through the thickness of the cylinder 50 within which hole 51 a tube or straw 52 is sealingly secured. The piston 5 is configured, i.e. sized and dimensioned, to cooperate with the internal surfaces of the body 3 to provide a substantially fluidic and/or airtight seal. The straw 52 in this embodiment includes a mouthpiece 53 at its free end 54 and a plurality of corrugations 55 along its length which provide flexibility to the straw 52. The components 50, 51, 52 of the piston 5 are formed of a plastics material, polypropylene in this embodiment.

The closure film 7 approximates the external dimensions of the peripheral flange 31, includes a protruding tab 70 and is formed of a foil coated with plastics material in this embodiment.

In order to prepare the dispensing container 1, the body 3 is filled with semi-solid food 2, e.g. yoghurt, and the piston 5 is inserted into the body 3 with the straw 52 extending upwardly therefrom until the bottom 56 of the piston 5 contacts the semi-solid food 2. The straw 52 is then curled and placed into the body 3 and the closure film 7 is aligned with and placed on the peripheral flange 31 and adhered or bonded thereto, for example using an adhesive, ultrasonic welding or thermal bonding as shown schematically in FIG. 2.

In use and in order to consume the semi-solid food 2, the closure film 7 is removed by gripping and peeling P the tab 70 and the straw 52 is straightened such that it extends upwardly from the piston 5. As shown schematically in FIG. 3, a user (not shown) applies his or her mouth (not shown) to the mouthpiece 53 and sucks S semi-solid food 2 from the container 1, which creates a pressure differential or vacuum within a reservoir defined between the internal surfaces of the body 3, the base 4 and the face 56 of the piston 5 which faces the semi-solid food 2. This pressure differential or vacuum causes the piston 5 to move toward the base 4 (or vice versa as illustrated by the arrows in FIG. 3), as the semi-solid food 2 is drawn up the straw 52, out of the mouthpiece 53 and into the user's mouth (not shown).

It will be appreciated that this arrangement enables a user or consumer (not shown) to consume the contents 2 of the dispensing container 1 immediately after it is purchased. Moreover, the consumption is carried out in a fast, clean and effective manner.

Referring now to FIG. 4, there is shown a dispensing container 100 according to a second embodiment, which is similar to the container 1 according to the first embodiment such that like references depict like features and consequently these will not be described further. The container 100 according to in this embodiment differs from that of the first embodiment in that the solid cylinder 50 of the piston 5 is replaced with a piston 105 which includes a disc 150 with a side skirt 157 extending upwardly from the peripheral edge thereof. The disc 150 includes an aperture or hole 151 through its thickness within which the straw 52 is sealingly secured.

The closure film 7 in this embodiment also includes a perforated line 71 adjacent and/or about the periphery or about a margin of the film 7 and the tab 70 is omitted. In use, a user (not shown) pierces the film 7 on the perforated line 71, then tears and removes the portion of the film 7 defined within the line 71 before extracting the straw 52 for use. The portion of the closure film 7 that remains on the dispensing container 100 provides an inwardly extending lip that prevents removal of the piston 105.

The main advantage of the configuration of the piston 105 of the container 100 according to this embodiment is the cost and use of minimal materials in manufacturing the piston 105. More specifically, the piston 105 according to this embodiment may be formed from a single blank of paper or plastics material formed into the open top hollow bottom cylinder 105 shown in FIG. 4. The side skirt 157 may be formed by folding the aforementioned blank with a draft angle to ensure an effective seal against the internal surfaces of the body 3.

FIG. 5 shows a dispensing container 200 according to a third embodiment, which is similar to the container 1, 100 according to the first and second embodiments such that like references depict like features and consequently these will not be described further. The container 200 according to in this embodiment differs from that of the second embodiment in that the side skirt 257 includes two scraping flanges 258 protruding therefrom. These scraping flanges 258 are folds formed in the side skirt 257 that cooperate, in use, with the internal surfaces of the hollow body 3 to scrape food residue therefrom as the piston 205 moves along the hollow body 3.

FIG. 6 shows a dispensing container 300 according to a fourth embodiment, which is similar to the containers 1, 100, 200 of the previous embodiments wherein like references depict like features and consequently these will not be described further. The container 300 according to in this embodiment differs from that of the second embodiment in that the closure film 7 is replaced with a semi-rigid lid 307 through which the mouthpiece 353 of the straw 105 extends and to which it is secured. The lid 307 includes a side skirt 371 and is adhered or bonded to the peripheral flange 331 of the body 103 using, for example, an adhesive, ultrasonic welding or thermal bonding. The container 300 also includes a closure cap 372 to cover the mouthpiece 353, which cap 372 includes a tamper evidence band 373 that engages a flange 355 on the mouthpiece in use to provide a tamper evidence feature in the normal way.

In order to prepare the dispensing container 300, the body 303 is filled with semi-solid food 2, e.g. yoghurt, and the piston 105 is inserted into the body 103 with the straw 52 extending upwardly therefrom until the bottom 56 of the piston 105 contacts the semi-solid food 2. The straw 52 is then curled and placed into the body 303 and the lid 307 is aligned with and placed on the peripheral flange 331 and adhered or bonded thereto, for example using an adhesive, ultrasonic welding or thermal bonding. The cap 372 is then press-fitted over the mouthpiece 353 such that the tamper evidence band 373 engages the flange 355.

In use and in order to consume the semi-solid food 2, the cap 372 is removed by gripping and pulling it until the tamper evidence band 373 tears off. A user (not shown) then applies his or her mouth (not shown) to the mouthpiece 353 and sucks semi-solid food 2 from the container 300, which creates a pressure differential or vacuum within a reservoir defined between the internal surfaces of the body 303, the base 4 and the face 56 of the piston 105 which faces the semi-solid food 2. This pressure differential or vacuum causes the piston 105 to move toward the base 4 (or vice versa), as the semi-solid food 2 is drawn up the straw 52, out of the mouthpiece 53 and into the user's mouth (not shown). This causes the straw 52 to unravel and stretch until substantially all of the semi-solid food 2 is consumed.

FIG. 7 shows a dispensing container 400 according to a fifth embodiment, which is similar to the containers 1, 100, 200, 300 of the previous embodiments such that like references depict like features and consequently these will not be described further. The container 400 according to in this embodiment differs from that of the second embodiment in that the straw 52 is removably secured to the piston 405. More specifically, a lower portion of the straw 52 receives a spigot portion 451 protruding from the disc 150 of the piston 405 by an interference fit.

In use, a user (not shown) removes the portion of the closure film 7 defined by the perforated line 71 as described above, removes the straw 52 and inserts the spigot portion 451 into the base of the straw 52 with sufficient force to ensure a tight fit therebetween. The semi-solid food 2 is then consumed through the straw 52 as described above.

FIG. 8 shows a dispensing container 500 according to a sixth embodiment, which is similar to the containers 1, 100, 200, 300, 400 of the previous embodiments such that like references depict like features and consequently these will not be described further. The container 500 according to in this embodiment differs from that of previous embodiments in that it is oval in shape instead of round, it includes a pair of parallel perforated lines 571 in the closure film 507 and it includes a clip 558 for releasably securing the straw 52, which is connected to a hole 551 that is offset from the centre of the disc 550 of the piston 505 in this embodiment. The clip 558 includes a circular receptacle 559 with a pair of opposed lips to releasably receive and secure the mouthpiece 53 relative to the piston 505.

In use, a user (not shown) grips the tab 70 and removes the portion of the closure film 7 defined between the perforated lines 571 to expose the straw 52. The mouthpiece 53 of the straw is gripped and removed from the clip 558 and the semi-solid food 2 is consumed as described above. It will be appreciated that the portion of the closure film 7 that remains on the dispensing container 500 provides a pair of inwardly extending lips that prevent removal of the piston 505.

FIG. 9 shows a dispensing container 600 according to a seventh embodiment, which is similar to the containers 1, 100, 200, 300, 400, 500 of the previous embodiments such that like references depict like features and consequently these will not be described further. The container 600 according to in this embodiment differs from that of the second embodiment in that the straw 652 is in the form of a flattened tube folded in alternating directions. The flat straw 652 is formed of a material with a structural memory such that it expands to a circular shape when it is released, in use, from the recess of the piston 105. The straw 652 includes an end portion 653 adjacent the free end 654 of the straw 652 functions as a mouthpiece 653 in this embodiment. This arrangement is simpler and more cost effective to manufacture.

FIG. 10 shows a dispensing container 700 according to an eighth embodiment, which is similar to the containers 1, 100, 200, 300, 400, 500, 600 of the previous embodiments such that like references depict like features and consequently these will not be described further. The container 700 according to in this embodiment differs from that of previous embodiments in that the piston assembly 705 includes a straw 752 that is semi-rigid, a spigot portion 751 that is flexible and an anti-removal flange 8. The straw 752 includes corrugations 55 at its centre to provide some flexibility so that it may be located within the piston 705 when the lid 7 is in place. The spigot portion 751 also includes corrugations 755 to provide it with some flexibility. The anti-removal flange 8 is formed of a sheet, formed of a plastics material in this embodiment, that is folded into two leaves each of which includes an aperture or hole through which the spigot portion 751 and the straw 752 extend.

It is envisaged that this container may be re-used, hence the anti-removal flange 8. More specifically, when the contents of the container are emptied the user (not shown) can grip and pull the straw 752 to draw the piston 705 out from the body 3. It will be appreciated that the pulling action will cause the flange 8 to extend, thereby causing the upper and lower edges of the holes therein to bear down against the adjacent outer surfaces of the spigot portion 751 and the straw 752, which prevents relative movement therebetween. Thus, the straw is retained within the spigot allowing the piston 705 to be removed conveniently.

FIG. 11 shows a dispensing container 800 according to a ninth embodiment, which is similar to the containers 1, 100, 200, 300, 400, 500, 600, 700 of the previous embodiments such that like references depict like features and consequently these will not be described further. The container 800 according to in this embodiment is specifically designed for multi-use applications. The container 800 differs from that of previous embodiments in that the body 803 is rigid and includes two handles 832 on one side thereof and the piston assembly 805 includes a chin rest 809. The handles 832 are secured to the body 803 by respective brackets 833 and each handle 832 is tubular with a resilient elastomeric band 834 secured within it. The other end of each elastomeric band 834 has a rigid strip 835 attached to it. The chin rest 809 includes a foam pad and is releasably secured to the bottom wall 150 of the piston 805 by a column 890 and the column 890 is releasably secured to the straw 852, which is rigid in this embodiment, by a releasable connector 891. The chin rest 809 also includes a support 892 formed of transparent plastics material with a pair of holes 893, each of which is configured to receive and engage one of the resilient bands 834 by inserting and reorienting its rigid strip 835 therethrough.

In use, semi-solid food is placed in the body 803, the piston 805 is placed in the top of the body 803 and the rigid strips 835 are inserted through the holes 893 and reoriented to engage the resilient bands with the support 892. These resilient bands 834 are configured to provide a predetermined force on the piston 805 to urge it against the semi-solid food in order to minimise the level of suction required to cause the food to rise up the straw 852. The user (not shown) rests his or her chin on the chin rest 809 and applies a gentle sucking action to the mouthpiece 53 and, if necessary, a slight pressure to the chin rest 809 with his or her chin to cause the food to rise up the straw 852 and be dispensed for consumption.

For storage, the straw 852 is configured to fit into one of the handles 832 by virtue of its external diameter being less than the internal diameter of the handles 832.

Referring now to FIG. 12, there is shown dispensing container 900 according to a tenth embodiment, which is similar to the containers 1, 100, 200, 300, 400, 500, 600, 700, 800 of the previous embodiments such that like references depict like features and consequently these will not be described further. The container 900 according to in this embodiment includes a semi-rigid lid 907, through which the straw 852 extends and is slideable, a chin rest 909 that incorporates a connecting element 990 for removably connecting the chin rest 909 to the straw 852 and is substantially elliptical in plan.

The lid 907 includes a side skirt 971 and is connected to the body 30 by a snap fit as a result of the cooperation between an external lip (not shown) on the body 30 and a groove (not shown) in the side skirt 971 of the lid 907. The chin rest 909 includes a half elliptical shaped semi-rigid foam pad section 991. The connecting element 990 includes three tabs or leaves 992a, 992b, 992c that extend from the pad section 991 at an angle to one another to provide a connector similar to the anti-removal flange 8 of the eighth embodiment. The tabs or leaves 992a, 992b, 992c are formed of a plastics material.

In use, a force applied to the pad section 991 by a user's chin will cause the connecting element 990 to tilt and bear down on the straw 852, thereby gripping the straw 852 and forcing the piston 157 in a downward direction. The diameter and wall thickness of the straw 852 are selected to ensure that it is sufficiently rigid to prevent the straw 852 from bending when a force is applied to the pad section 991 of the chin rest 909.

It will be appreciated by those skilled in the art that the larger or wider the tube, more particularly the internal dimensions or diameter of the tube, the easier it is for a user or consumer to suck the contents of the dispensing container 1, 100, 200, 300, 400, 500, 600, 700, 800, 900. It has been observed that an internal diameter of 3 to 25 millimetres is advantageous, while an internal diameter of 5 to 20 millimetres is preferable, an internal diameter of 7 to 18 is more preferable and an internal diameter of 10 to 15 is most preferable.

It will be appreciated by those skilled in the art that several variations are envisaged without departing from the scope of the invention. For example, the piston 5, 105, 205 and/or hollow body 3 may take any suitable form and need not be in the form or shape shown. The piston 5, 105, 205 may comprise a hollow cylinder or plate and/or it may be square, rectangular, octagonal, oval or any other suitable shape or form. The piston 5, 105, 205 may include sealing formations either formed integrally therewith or as initially separate members attached thereto or associated therewith. The bottom 56 of the piston 5 may be concave, e.g. to provide improved sealing wherein the vacuum or pressure differential in the reservoir may cause the bottom 56 to straightened, thereby expanding its external dimensions. Alternatively, the bottom 56 may be convex to ensure that a maximum amount of semi-solid food 2 is extracted from the container 1, 100, 200. The closure film 7 may be replaced by a snap-on or screw top lid or any other suitable type of closure and/or may comprise a tamper evident means or member.

Moreover, the anti-removal tab 8 may be omitted from the eighth embodiment and/or the chin rest 809 and/or the resilient bands 892 of the ninth embodiment need not be present where their use is not required.

It will also be appreciated that any number of combinations of the aforementioned features and/or those shown in the appended drawings provide clear advantages over the prior art and are therefore within the scope of the invention described herein.

1. A dispensing container for storing and dispensing semi-solid foods, the container comprising a hollow body, a base, a piston with a passage therethrough and a tube releasably secured to the piston for movement therewith and in fluid communication with the passage, wherein the piston is slidably received within the body and movable therealong toward the base to dispense; in use, through the tube a liquid and/or semi-solid food from the container.

2. Container according to claim 1 further comprising further comprising an actuator connected to the piston for urging, in use, the piston toward the base.

3. Container according to claim 2, wherein the actuator comprises a biasing element for biasing, in use, the piston toward the base.

4. Container according to claim 2, wherein the actuator comprises an actuation member releasably secured to the piston and/or tube.

5. Container according to claim 1 further comprising an anti-removal tab interconnecting the tube and the piston.

6. Container according to claim 1, wherein the tube is flexible and/or corrugated and/or folded or foldable.

7. Container according to claim 1, wherein the piston comprises a recess within which the tube is receivable.

8. Container according to claim 7, wherein the piston comprises a base panel with a skirt extending from a peripheral portion thereof that defines the recess.

9. Container according to claim 8, wherein the base panel comprises a hole through its thickness to provide the passage.

10. Container according to claim 1 further comprising a scraping or sealing element associated with the piston that cooperates with one or more internal surfaces of the hollow body to scrape food residue therefrom and/or to provide a sealing engagement therewith.

11. Container according to claim 1 further comprising a closure.

12. Container according to claim 11, wherein the closure comprises a foil, film or sheet adhered or bonded to a rim of the tubular body.

13. Container according to claim 12, wherein the closure comprises a perforated line defining a removable portion of the closure, the perforated line being configured such that a portion of the closure remains on the tubular body, in use, to inhibit removal of the piston.

14. Container according to claim 1 further comprising a clip for releasably securing the flexible tube to the container or piston.

15. Container according to claim 11, wherein the closure comprises snap-on or screw top lid.

16. Container according to claim 15, wherein the tube is connected or connectable to and/or extends through the lid.

17. Container according to claim 16 further comprising a cap for covering an open end of the straw.

18. (canceled)

19. Package including at least one container according to claim 1 containing a semi-solid food product.
